(19) United States
(12) Patent Application Publication
(10) Pub. No.: US 2011/0224327 A1
(43) Pub. Date: Sep. 15, 2011

(54) HIGH HEAT RESISTANT NON-SKID COATINGS

(75) Inventors: Nadia Kardash, Cliffside Park, NJ (US); Thomas J. Gooney, Houston, TX (US); Nick Tatavak, Houston, TX (US); Timothy TM Harris, Rahway, NJ (US)

(73) Assignee: AKZO NOBEL COATINGS INTERNATIONAL B.V., Arnhem (NL)

(21) Appl. No.: 13/123,169

(22) PCT Filed: Mar. 1, 2010
(86) PCT No.: PCT/US2010/025719

§ 371 Date: May 23, 2011

Related U.S. Application Data
(60) Provisional application No. 61/155,952, filed on Feb. 27, 2009.

(30) Foreign Application Priority Data
May 12, 2009 (EP) 9160041.1

(51) Int. Cl. C09K 3/14

(52) U.S. Cl. 523/150

(57) ABSTRACT

A composition comprising a base and curing agent that when mixed, applied to a substrate and cured, comprise a thick non-skid coating having a plow field texture with an aggressive profile and with exceptional mechanical properties which are maintained after exposure to high heat conditions.

This application claims priority based on U.S. Provisional Application No. 61/155,952, filed Feb. 27, 2009; and European Patent Application No. 9160041.1, filed May 12, 2009, the contents of which are incorporated herein by reference in their entirety.

### BACKGROUND OF THE INVENTION

The present invention relates to high heat resistant non-skid coatings. Anti-skid coating compositions, particularly suitable for use in heavy duty marine applications are well known. Such compositions are typically based on epoxy resins. Epoxy coatings have excellent adhesion to various substrates, chemical and corrosion resistance and mechanical properties, but they are prone to “chalking” under UV-radiation and weather elements. Polysiloxanes on the contrary have outstanding weathering resistance. Sometimes to improve UV- or weather resistance of epoxy coatings they are modified by polysiloxanes or, on the contrary, polysiloxanes are modified by epoxy resins to achieve better adhesion, mechanical properties or ambient temperature cure. Usually such compositions contain various fillers and/or aggregates, such as abrasion resistance improvers and pigments.

European Patent Application EP 1 526 150 A1 discloses an anti-skid coating composition including a polysiloxane characterized by stoichiometric formulas such as Rₐ¹R_{b}²(R¹⁰O)_{c}SiO_{(4-a-b-c)/2}, where each R¹⁰ is independently selected from hydrogen, allyl, aryl or —R³—(X)₂, and R¹ is selected from the group comprising alkyl and aryl radicals, R² is selected from the group comprising hydrogen, alkyl and aryl radicals, a and b are each a real number from 0.0 to 2.0, c is a real number from 0.1 to 1.0 and a+b+c is lower than 4. Various reactive functional groups may be associated with the formula, including epoxy.

U.S. Pat. No. 3,350,330 discloses a non-skid weather resistant coating composition comprising a silanol-terminated diorganopolysiloxane, a solvent and sand that has been treated with a silane.

French Patent No. 1,464,986 discloses a non-skid composition comprising diorganosiloxane, an inorganic reinforcing material, an organic solvent, a major proportion of sand treated with hydrolysable silanes and asbestos material.

U.S. Pat. No. 4,774,278 discloses a coating composition with improved surface properties comprising an organic resin, which may be an epoxy resin, a silicone resin and an organopolysiloxane. The required organopolysiloxane is one having at least one substituting group selected from the class consisting of aminoalkyl groups, mercaptoalkyl groups and dihydroxyalkylamino-substituted hydrocarbon groups in a molecule. The interaction between all three resins is claimed to impart improved anti-blocking and anti-slip properties to the thin films (2.5 g/sq ft) with relatively low mechanical strength of such compositions.

Other references, such as U.S. Pat. No. 5,053,077, GB 2,188,643, and U.S. Pat. Nos. 4,879,066; 7,057,958; and 6,632,860 are concerned with various ingredients that might be used in a coating composition, such as frits, ceramic powder, alumina trihydrate, epoxy with amine curing agent, glass fibers, pigments, fire retarding agents and abrasive aggregates.

However, none of these references disclose coatings that have both initial and post heat exposure mechanical properties that are acceptable for the requirements of high heat resistant non-skid coatings for use with modern VTOL aircraft. It would be desirable to have a non-skid coating that is easy to apply, with acceptable mechanical and corrosion resistant properties when cured at ambient temperatures and that also maintains acceptable mechanical and corrosion resistant properties after exposure to high heat conditions.

### SUMMARY OF THE INVENTION

According to the present invention, it has now been found that a coating composition can be prepared that has the properties of easy application, acceptable mechanical and protective properties when cured at ambient temperature and acceptable mechanical and protective properties after exposure to high heat conditions. The coating according to the invention utilizes a combination of epoxy and silicone resins, and a relatively high content of fillers, fibers, aggregates, and functional additives.

In one embodiment, the present invention is a composition comprising a base and curing agent that when mixed, applied to a substrate and cured comprise a thick (preferably about 250 to about 350 g/sq ft) non-skid coating having a plough field texture with aggressive profile (the peaks being about 12.5 to about 25 mm apart, and up to about 1.5 mm-2.4 mm high) and exceptional mechanical and heat resistance properties. The base comprises from about 5% to about 20% by weight of one or more epoxy resins, and from about 10% to about 40% by weight of one or more silicone resins. From about 40 to 85% by weight of the base comprise mineral and/or ceramic fillers, fibers and/or aggregate, and functional additives. The curing agent comprises from about 20 to about 55% by weight of one or more amine functional curing agents, and from about 45 to 80% by weight of mineral and/or ceramic fillers and/or fibers, and functional additives.

In one embodiment, the base comprises from about 8% to about 16% by weight, or from about 8% to about 14% by weight, of one or more epoxy resins, and from about 10% to about 20% by weight, or from about 11% to about 16%, of one or more silicone resins. In an embodiment of the invention, the ratio of total silicone resin to total epoxy resin is greater than 1:1, or greater than about 1.1:1, or greater than about 1.15:1. In one embodiment, the base comprises from about 50 to 80% by weight, or about 60 to about 80% by weight, or about 70 to about 80% by weight, of mineral and/or ceramic fillers and/or fibers, and functional additives. In one embodiment, the curing agent comprises from about 30 to about 50% by weight, or about 35 to about 45% by weight, of one or more amine functional curing agents, and from about 50 to 70% by weight, or about 55 to about 65% by weight, of mineral and/or ceramic fillers and/or fibers, and functional additives. In one embodiment, the ratio of base to curing agent is at least 5:1, or at least 6:1.

Other embodiments of the invention relate to details concerning various components of the composition of the invention, relative amounts of components and physical properties of components, all of which are described below.

### DETAILED DESCRIPTION OF THE INVENTION

The invention relates to high heat resistant heavy duty non-skid coatings. Such coatings are useful, for example, for aircraft carrier flight decks.

The coating of the invention is referred to as a “two pack” coating, meaning two major components, a base and a curing agent. The composition, as a whole, includes epoxy resins (broadly organic resins) with epoxy curing agents, silicone resins, aluminium trihydrate (broadly fire retardant materials), aluminium and/or aluminium oxide granules (broadly texturizing fillers), silica based materials (e.g., aerosil pyrogenic silica) and mineral fibers (broadly thixotropic agents), ceramic and or glass frits (such as commercially available from CEEPREE Products Ltd.), mica, and, optionally, solvent and pigments.

The coating of the invention achieves its non-skid properties from use of special fillers and aggregates in combination with unique rheology of the composition.

The applied coating is thick with a dendrite or plough field texture, and remains so after curing to provide a non-skid surface to assist in landing and takeoff of aircrafts on an aircraft carrier deck. It can withstand exposure to very high temperatures, e.g. 1800° F. (982° C.), for a short period of time, e.g., 7 to 30 seconds or 10 to 20 seconds, and can withstand temperatures of about 500° F. (260° C.) for repeated periods, e.g., repeated heating at 260° C. for 90 minutes and cooling for 30 minutes, without flaming and while maintaining mechanical integrity (i.e. without cracking, disintegrating or losing adhesion).

The invention has several aspects: the combination of dendrite or ploughed texture (the textured appearance of the invention of roughly parallel rows of raised coating, forming peaks or ridges on the coating surface is referred to as plough field surface or dendrite) and heat resistance (while maintaining non-skid properties and mechanical integrity) at the extreme conditions to which the coating surface is exposed. More specifically, previous compositions based on organic resins can provide thick coating with the dendrite or plough texture which imparts non-skid properties, but such coatings do not withstand high heat. The applied coating composition according to the invention, although based on organic resins, does not disintegrate under high heat and maintains required non-skid, protective and mechanical properties.

The high level of heat resistance is an important aspect of the invention which allows the coating to continue to protect and provide a non-skid surface after multiple exposures to high heat, as opposed to a fire retardant coating which protects while it chars or burns and then has to be scrapped. Finally, while epoxy resins cure at ambient temperature, silicone resins usually require high heat to cure for full development of its properties (e.g. 45 minutes at 250° C.). Thus, it is an aspect of the invention that the composition including silicone resins hardens at ambient temperature and does not require high heat cure to develop its heat resistance and mechanical properties allowing it to withstand multiple take offs and landings of the aircraft and to perform its non-skid function.

The preferred silicone resin employed in the invention comprises at least one of a functional silicone resin having repeating units with the formulae R¹R²SiO_{2/2} or R¹R²SiO_{3/2}, where R¹ and R² are independently selected from the group consisting of alkyl, vinyl, allyl, methoxy, ethoxy and phenyl. The alkyls may comprise methyl or ethyl. R¹ and R² may comprise alkyl and phenyl, respectively.

In one embodiment, the base contains at least two different alkyl-phenyl polysiloxane silicone resins, with a first resin being a methoxy-functional polysiloxane (or silicone intermediate) and a second resin being a non-reactive or silanol-functional polysiloxane (or silicone intermediate). Examples of commercially available polysiloxane resins useful as the first resin are Silres® SY231 and Silres® IC232, both available from Wacker Chemie AG. Examples of commercially available polysiloxane resins useful as the second resin are Silres® Ren80 and Silres® SY409, both available from Wacker Chemie AG.

In one embodiment, the second resin is a silanol-functional resin. In embodiments of the invention, the silanol functional resin has hydroxyl content in the range of about 1 to about 5%, or about 1.5 to about 4.5%, or about 3%. In an embodiment of the invention, the first resin has a lower molecular weight than the second resin. In embodiments of the invention, the second resin has a molecular weight of at least 7,500, or at least 8,500, or at least about 9,500 or at least about 10,000. In one embodiment, the weight ratio of the second resin to the first resin is at least 60:40, or at least about 70:30, or at least about 80:20.

Preferred epoxy resins used in the composition of the invention may be selected from the group consisting of Bisphenol A, Bisphenol F, Novolac, Cycloaliphatic, Aliphatic, Polyglycol and/or various polyglycidyl ether based epoxy resins, or their derivatives.

In one embodiment, the base contains at least two different epoxy resins, with a first resin being an epoxy diluent and a second resin being an aromatic type epoxy. Examples of commercially available epoxy resins useful as the first resin are mono-, di- or triglycidyl ethers, such as O-Cresyl Glycidyl Ether, Neopentyl Glycol Diglycidyl Ether or Polyglycidyl Ether of Castor Oil available from Hexion (Heloxy 62, 68, 505), or Nonyl Phenyl Glycidyl Ether, Polypropylene Glycol Diglycidyl Ether or Trimethylolpropane Triglycidyl Ether available from CVC Specialty Chemicals (Erisys GE-12, GE-23, GE-30) or polyglycol diepoxides from Dow such as DER732 and DER736. Examples of commercially available epoxy resins useful as the second resin are Epon 834, Epon 828, Epon 862, Epon 1001, Eponex 1510 and Heloxy 107, available from Hexion, or DER 331 and DEN 431 from Dow Chemical, or Epalloy 8220/8230 from CVC Specialty Chemicals.

In embodiments of the invention, the second resin can be an aromatic type of epoxy resin chosen from bisphenol A, bisphenol F and novolac epoxy resins. In one embodiment, the second resin is a bisphenol A epoxy resin. In an embodiment of the invention, the first epoxy resin has lower viscosity than the second epoxy resin. In embodiments of the invention, the second epoxy resin has a viscosity of at least 1800 cps (25*C), or at least 6000 cps, or at least about 12000 cps. In one embodiment, the weight ratio of the second resin to the first resin is at least 50:50, or at least about 55:45, or at least about 60:40.

Preferred amine functional curing agents may be selected from the group consisting of aliphatic amines, cycloaliphatic amines, poyamides, modified amines, polyoxyalkylenepolyamines, polyamidoamines, polyimidazolines, and their derivatives, adducts or modifications.

In one embodiment, the base contains at least two different amine functional curing agents, with a first amine curing agent being a modified polyamine and a second amine curing agent being a cycloaliphatic amine. Examples of commercially available amine curing agents useful as the first amine curing agent are Versamine S-2 available from Cognis or Epi-cure 3378 available from Hexion. Examples of commercially available amine curing agents useful as the second amine curing agent are Ancamine 2074 or Ancamine 1618, available from Air Products or Versamine C-30 or C-31 from Cognis. In embodiments of the invention, the modified polyamine is present in an amount of at least 45 wt %, or at least 50 wt %, or at least about 55 wt % based on the total amount of amine curing agents. Polyamides and polyamidoamines from Cognis such as Versamid 150, Versamid 253, Genamid 151, Genamid 250, Genamid 490 or Genamid 747 can also be used.

The preferred weight ratio of base to curing agent is from about 7:1 to about 4:1. In embodiments of the invention, the lower limit of this range is at least 5:1, or at least 6:1, or at least about 6.5:1.

The curing agent may include one or more catalysts, such as tertiary amine accelerators (Lewis-Base Catalysts), inorganic salts, organic sulfonic acids, metal alkoxide chelates, alkoxy titanates, amine complexes (Lewis-Acid Catalysts). In one embodiment, the curing agent includes a metal alkoxide chelate type catalyst. In one embodiment, the catalyst is a titanium alkoxide catalyst. Examples of commercially available titanium alkoxide catalysts useful in the curing agent include Vertec XL101, PBT, XL110, XL115, and XL155 from Johnson Matthey. In embodiments of the invention, the catalyst is present in the curing agent in an amount in the range of about 2 to about 20 wt %, or about 5 to about 17 wt %, or about 10 to about 15 wt %.

Functional additives, both in the base and curing agent, may be selected from the group consisting of rheological modifiers, antifoaming agents, plasticizers, reinforcing agents, flow control agents, flame retardants, dispersing aids and mixtures thereof.

The mineral and/or ceramic fillers, fibers and/or aggregate used in the composition of the invention may be selected from the group consisting of aluminum oxide, corundum, garnet, glass, metal grains, nepheline syenite, feldspar, micas, barites, talc, clays, pumice, magnesium oxide, slags, tungsten carbide, wollastonite, ceramic or mineral fibers, ceramic or glass frits, ceramic spheres, and mixtures thereof. In embodiments of the invention, the particle size of the fillers, fibers and aggregate can be in the range from about 325 to about 8 mesh, or about 200 to about 8 mesh, or about 100 to about 8 mesh.

In embodiments of the invention, the composition of the invention contains aluminium oxide in an amount of at least 10 wt %, or at least about 15 wt %, or at least about 20 wt %, based on the weight of the total composition. In embodiments of the invention, the base contains aluminium oxide in an amount of at least 14 wt %, or at least about 18 wt %, or at least about 22 wt %. In embodiments of the invention, the aluminium oxide has a particle size smaller than 24 mesh, or smaller than about 40 mesh, or smaller than about 50 mesh, or smaller than about 60 mesh, or smaller than about 70 mesh, or smaller than about 80 mesh, or smaller than about 90 mesh, or smaller than about 100 mesh. The aluminium oxide can be in the range of about 100 to about 24 mesh, or about 90 to about 30 mesh, or about 80 to about 40 mesh, or about 70 to about 50 mesh.

In an embodiment of the invention, the composition of the invention includes silica based colloidal inorganic particulate material. In one embodiment, the silica based material is selected from silica, pyrogenic silica and combinations thereof. In one embodiment, the composition includes pyrogenic silica. The pyrogenic silica can be included in the base, the curing agent or both. In one embodiment, the pyrogenic silica is included in both the base and curing agent. In such an embodiment, the silica can be in the base in an amount from about 0.01 to about 2 wt %, or about 0.1 to about 1.5 wt %, or about 0.5 to about 1.2 wt %, based on the weight of the base, and can be in the curing agent in an amount from about 0.1 to about 4 wt %, or about 0.5 to about 3.5 wt %, or about 1 to about 2.5 wt %, based on the weight of the curing agent.

The composition of the invention may include various inorganic or mixed metal oxide pigments.

In embodiments of the invention, the VOC of the composition is less than 100 g/l, or less than 75 g/l, or less than about 50 g/l, or less than about 45 g/l.

A typical preferred composition of the invention may be summarized as follows:

For the total formula weight percentages are:

| | | |
|---|---|---|
| Epoxy resins | 8.0-12.0% | Organic resins |
| Modified Amines | 3.0-6.0% | Amine functional |
| | | curing agents |
| Silicones | 10.0-15.0% | Silicone Resins |
| Aluminum Trihydrate | 8.0-12.0% | Fire Retardant |
| Aerosil (pyrogenic silica) | 0.5-3.0% | Thixotropic additive |
| Mica | 3.0-6.0% | |
| Glass Frits | 3.0-6.0% | Ceramic and Mineral |
| Mineral Fibers | 2.0-5.0% | fillers, reinforcing agents |
| | | and aggregate |
| Aluminum Oxide | 15.0-25.0% | |
| Ceramic filler | 3.0-5.0% | |
| Feldspar | 1.0-3.0% | |
| Aluminum | 18.0-25.0% | Metallic filler |
| Pigments (inorganic or | 1.0-3.0% | |
| mixed metal oxide) | | |
| Solvent | 0.1-1.0% | |

Catalyst/coupling agent can be added for faster ambient temperature cure. Also, it can be seen that there is very little solvent in the above formula.

The composition of the above formula has a fast cure, is easy to apply and has an aggressive profile. It is compliant with the requirements of the MIL-PRF-24667C for flight deck coatings, and passes NAVY Research Lab testing approximating Osprey-V22 operations on the flight deck, with multiple exposures up to 500° F.

A preferred method of applying the coating of the invention is by use of a napless phenolic core roller. The material should be rolled only in one direction in slow straight strokes with a moderate amount of pressure on the handle to create a uniformly rough surface of ridges and valleys similar to a plowed field. The peaks of the ridges are preferably about 0.5-1.0 inch (12.5-25 mm) apart and about 1/16- 3/16 inch (1.5-2.4 mm) high. Thick, carelessly applied coats should be avoided since they will result in poor cure, mud cracking and insufficient coverage.

In order to achieve a coating having acceptable mechanical properties both initially and after exposure to high heat, the inventors have found that a balance between the silicone and epoxy resins must be provided, where the epoxy resins provide good mechanical properties after ambient curing and where the silicone resins provide good mechanical properties after high heat exposure. It is believed that when the composition according to the invention is exposed to high heat conditions, the organic components of the epoxy are destroyed (or burned off) and the resulting coating is essentially inorganic with a new ceramic phase being created. This resulting coating retains excellent mechanical properties under repeated high heat exposure.

The coatings according to the invention comply with the requirements for Impact Resistance, Wear Resistance and Coefficient of Friction according to MIL-PRF-24667C, the contents of which is incorporated herein by reference, both initially (after ambient curing) and after high heat exposure. In embodiments of the invention high heat exposure includes exposure to 260° C. for 30 minutes, or for 60 minutes, or for 90 minutes. In embodiments of the invention high heat exposure includes repeated cycles of exposure to 260° C. for a period of 30 minutes, or for 60 minutes, or for 90 minutes, and cooling at ambient temperature for 30 minutes. In embodiments of the invention such cycles are repeated for at least four cycles, or at least eight cycles, or at least twelve cycles, or at least 16 cycles.

The Impact Resistance test involves applying the test coating to four 150 by 150 by 6-millimeter (nominal) steel test panels prepared in accordance with MIL-PRF-24667C. Immediately before testing, two panels are subjected to each of the following treatments: (a) no treatment and (b) 15 days of immersion at room temperature in either natural seawater, or synthetic seawater in accordance with ASTM DI 141.

The impact test is conducted with a device similar to that depicted in ASTM G14, except that the v-block securing device is replaced with a steel base that is at least 1.5 inches (40 millimeters) thick, and is capable of securing the sample plate without allowing movement when impacted and allows alignment of the plate with the designated impact locations. The tup nose has a 15.875-millimeter hemispherical head and the weight of the tup modified so that it is 1.8 kilograms.

Immediately upon removal from treatment, each panel is subjected to 25 impacts by the tup dropped from a distance of 1.2 meters. The impacts on the panel are made in the sequence represented by table 1. Successive points of impact form a 5 by 5 pattern, enclosed within an area of about 58 square centimeters, in which the impacts are equally spaced 20±1.5 millimeters center-to-center from their nearest neighbors.

TABLE 1
Impact sequence for the impact resistance test.

| | | | | |
|---|---|---|---|---|
| 2 | 15 | 11 | 7 | 3 |
| 6 | 19 | 23 | 20 | 16 |
| 10 | 22 | 25 | 24 | 12 |
| 14 | 18 | 21 | 17 | 8 |
| 1 | 5 | 9 | 13 | 4 |

Upon completion of each impact test, the panel is probed by hand with a hand held, sharpened, 25.4 millimeters (nominal) steel cold chisel in an area that received no impacts in order to judge the force needed to remove the coating. The panel is then probed in the impact area with the chisel, using a force less than that used in the non-impact area, and coating which is been loosened by the impact of the steel ball is removed from the panel.

The percentage of coating system remaining intact and tightly adhering to the panel is evaluated as follows: In the 5 by 5 pattern of impacts, there are 40 pairs of impacts separated by 20 millimeters center to center. In every case in which one or more layers of the coating system has been removed with the chisel, so as to connect one pair of impacts, the percentage of intact coating system is reduced by 2.5. Thus, a passing value of 90 percent indicates that no more than four pairs of adjacent impacts are connected. Results for duplicate panels tested under the same conditions are averaged. Failure of one of the two conditions constitutes failure of this test. Impact resistance for each type shall be in accordance with the requirements of 3.6 of MIL-PRF-24667C.

The Wear Resistance test involves applying the test coating to three 300 by 150 by 3-millimeter (nominal) steel test panels prepared in accordance with MIL-PRF-24667C. The mass of each panel is measured to the nearest 0.5 gram before application of the coating system. Each panel is abraded by the cable abrasion tester (specified in 4.5.2 of MIL-PRF-24667C) for 50 cycles and then its mass determined. The panel is then worn for an additional 450 cycles in the cable abrasion tester. For abrasive coatings, the wire in the cable abrasion tester is replaced after the first 50 cycles and every 150 cycles thereafter. After completion of the wear, the final coating mass is taken. The percent of determined mass loss is calculated as follows:

Percent mass loss=100×(M2−M3)/(M2−MI), where MI is the mass of panel before coating, M2 is the mass at 50 cycles, and M3 is the mass at end of test.

The average percent of determined mass loss of the three panels is computed.

The Coefficient of friction (COF) is determined as follows and in accordance with the requirements of 3.4 of MIL-PRF-24667C. The COF test involves applying the test coating to six 150 by 300 by 6-millimeter (nominal) steel test panels prepared in accordance with MIL-PRF-24667C and coated with non-skid in accordance with the manufacturer's ASTM F718 data sheet. Roll-on non-skid coating materials are applied such that the ridges run parallel to the 300 millimeter dimension. Three of the test panels are subjected to 50 cycles of wear, which are designated as “unworn”, and three are subjected to 500 cycles of wear, designated as “worn”, in the cable abrasion tester.

The COF testing device is constructed of the following components:
a. The drag sled is constructed of a steel block having dimensions of 145 millimeters by 100 millimeters by 22 millimeters with one 100-millimeter edge having a 19-millimeter radius. The 100 millimeters by 22 millimeters face with the radius edge also receives a screw eye in the center of the face. The block is covered with a vulcanized neoprene rubber pad covering the two faces joined by the radius edge and the radius edge itself. The rubber pad has a Type “A” Durometer hardness of 57±2 and a nominal thickness of 3 millimeters. The total weight of the drag sled including the rubber pad and screw eye is 2.7±0.2 kilograms.
b. A force gage is used which can measure at least 4.5 kilograms with a minimum resolution of 0.01 kilogram. The gage shall also be able to output information to a PC for analysis. Chatillon force gage model DFS-0050 (Standard model) has been found acceptable for this application.
c. A computer program which can collect and save data from the force gage as well as analyze the data to determine the COF at the moment at which motion begins (static friction).
d. A platform which moves across a 25-millimeter minimum distance at a constant speed of 300 millimeters per minute (nominal).
e. The COF tester and the panels shall be securely fastened to a stable platform to ensure no extraneous slippage of the panels or the tester occurs, and that there will be no interference with the securing attachment and the motion of the sled.

The COF test is conducted on the six panels as prepared above. Each panel is subjected to this test procedure under the following three conditions:
a. COF test shall first be run with the panel dry.
b. After completion of the dry condition test, the panels shall be wetted with synthetic seawater in accordance with ASTM DI 141, and the tests shall be repeated.
c. After completion of the wet condition test, the panels shall be rinsed in tap water to remove the synthetic seawater, dried at 248° F. (120° C.) for 1 hour, and cooled to standard conditions. The panel is then wetted with aircraft turboshaft engine oil in accordance with MIL-PRF-23699, and the test is repeated.

The sled is placed rubber side down on the panel and connected to the force gage in such a way that no tension is experienced while minimizing slack between the force gage and the sled. The sled is moved across the panel at a rate of approximately 300 millimeters per minute. The sled is moved for approximately 5 seconds to give a travel distance of 25 millimeters. The computer program will determine COF data by dividing the force required to initiate movement of the sled by the weight of the sled and record the results. Five replicate measurements are made; the panel is then turned 90 degrees and five additional measurements are made. The average of the ten readings for each panel condition, unworn and worn, (30 total) shall be computed.

### EXAMPLES

The following examples have been carried out to illustrate some embodiments of compositions according to the invention.

The following materials were used in the examples below:

Epoxy resins:
Bisphenol A epoxy resin—Epon 828 or DER 331
Epoxy diluent—Trimethylolpropane Triglycidyl Ether

Silicone resins:
Methoxy-functional polysiloxane—Silres SY231 or IC232
Non-reactive or silanol-functional polysiloxane—Silres Ren80 or SY409

Amine curing agents:
Modified polyamine—Versamine S-2
Modified cycloaliphatic amine—Ancamine 2074
Amido-amine resin—Genamid 151
Tertiary amine—DMP 30

Ceramic, metallic and mineral fillers, mineral fibers, reinforcing agents and aggregate:
Mica (325 mesh)
Glass Frit (30 micron)
Aluminum oxide (60-24 mesh)
Aluminum granules (100-20 mesh)
Ceramic spheres (40 micron)
Sodium Potassium Aluminum Silicate—Minspar 4

Thixotropic agent:
Aerosil R202

### Example 1

A base was prepared by first charging 22.12 grams Bisphenol A epoxy, 9.48 grams epoxy diluent, 1.96 grams dispersant (BYK P104) and 0.97 grams organic blue pigment to a twin-shaft dispersing vessel. This combination was mixed for about 10 minutes, after which 10.0 grams mica, 1.3 grams titanium dioxide, 0.4 grams red iron oxide pigment, 4.0 grams black pigment, 3.6 grams thixotropic agent, 38.7 grams aluminium trihydrate and 16.6 grams glass frit were added and then dispersed at high speed at a temperature of about 145-155° F. (63-68° C.) for about 20 minutes. To this mixture was added under agitation 18.6 grams methoxy functional polysiloxane (SY231) and 29.2 grams non-reactive or silanol functional polysiloxane (Ren80). The mixture was then dispersed for about 5 minutes and then 77.9 grams aluminium oxide, 7.0 grams amorphous mineral fiber and 88.85 grams aluminium granules were added and the combination was well mixed.

### Example 2

Example 1 was repeated, except that the SY231 methoxy functional polysiloxane was replaced with IC232.

### Example 3

Example 1 was repeated, except that the Ren80 non-reactive or silanol functional polysiloxane was replaced with SY409.

### Example 4

Example 2 was repeated, except that the Ren80 non-reactive or silanol functional polysiloxane was replaced with SY409.

### Example 5

A curing agent was prepared by first charging 11.3 grams modified polyamine, 5.89 grams modified cycloaliphatic amine, 2.1 grams amido-amine resin and 0.72 grams of tertiary amine to a twin-shaft dispersing vessel and mixed for about 5 minutes. To this mixture was added under agitation 1.0 gram thixotropic agent, 13.06 grams ceramic spheres, 6.9 grams mica, 5.4 grams sodium potassium aluminum silicate, and 2.07 grams amorphous mineral fiber and then dispersed to smooth. To this mixture was added 1.2 grams methyl n-amyl ketone under agitation and then thoroughly mixed under low shear.

### Examples 6-9

The resulting base compositions from examples 1-4 were each mixed with the curing agent composition of example 5 to provide coating compositions according to the invention. Each of the coating compositions were applied to a steel plate test panel using a napless roller to achieve a coating having uniform appearance with a plough field surface texture. The coatings were allowed to cure at ambient temperature and the coating demonstrated sag resistance and retained the plough field surface texture through curing.

1. A composition comprising a base and curing agent which when mixed, applied to a substrate and cured comprise a non-skid coating having a plough field texture with exceptional mechanical properties, corrosion and heat resistance, said base comprising from about 5% to about 20% by weight of one or more epoxy resins, and from about 10% to about 40% by weight of one or more silicone resins, from about 40 to 85% by weight of said base comprising mineral and/or ceramic fillers, fibers and/or aggregate, and functional additives, wherein the weight ratio of silicone resin to epoxy resin is greater than 1:1, said curing agent comprising from about 20% to about 55% by weight of one or more amine functional curing agents, and from about 45% to 80% by weight of mineral and/or ceramic fillers and/or fibers, and functional additives, wherein the non-skid coating complies with impact resistance requirements according to MIL-PRF-24667C both upon ambient curing and after high heat exposure to 260° C. for 30 minutes.

2. The composition of claim 1 wherein said silicone resin comprises at least one of a functional polysiloxane resin having repeating units with the formulae R¹R²SiO_{2/2} or R¹R²SiO_{3/2} where R¹ and R² are independently selected from the group consisting of alkyl, vinyl, allyl, methoxy, ethoxy and phenyl.

3. The composition of claim 2 wherein said alkyl is chosen from methyl or ethyl.

4. The composition of claim 2 wherein R¹ and R² comprise alkyl and phenyl, respectively.

5. The composition of claim 1 wherein the base comprises at least two different alkyl phenyl silicone resins.

6. The composition of claim 5 wherein said at least two different alkyl phenyl silicone resins comprise a first resin being a methoxy-functional polysiloxane and a second resin being a non-reactive or silanol-functional polysiloxane.

7. The composition of claim 6 wherein the weight ratio of said second resin to said first resin is at least 60:40.

8. The composition of claim 7 wherein the weight ratio of said second resin to said first resin is at least about 80:20.

9. The composition of claim 7 wherein the weight ratio of said one or more silicone resins to said one or more epoxy resins is at least 1.1:1.

10. (canceled)

11. The composition of claim 1 wherein said base comprises from about 60 to about 80 wt % mineral and/or ceramic fillers, fibers and/or aggregate, and functional additives.

12. The composition of claim 11 wherein said base comprises at least about 70 wt % mineral and/or ceramic fillers, fibers and/or aggregate, and functional additives.

13. The composition of claim 12 wherein said curing agent comprises at least about 50 wt % mineral and/or ceramic fillers, fibers and/or aggregate, and functional additives.

14. The composition of claim 11 wherein said base comprises aluminium oxide in an amount of at least 18 wt %.

15. The composition of claim 14 wherein said aluminium oxide has a particle size smaller than about 50 mesh.

16. The composition of claim 15 wherein said base comprises pyrogenic silica in an amount of at least 0.5 wt %.

17. The composition of claim 16 wherein said curing agent comprises pyrogenic silica in an amount of at least 1.0 wt %.

18. The composition of claim 1 wherein said epoxy resins are selected from the group consisting of Bisphenol A, Bisphenol F, Novolac, Cycloaliphatic, Aliphatic, Polyglycol, various Polyglycidyl Ethers based epoxy resins, or their derivatives.

19. The composition of claim 1 wherein said amine functional curing agents are selected from the group consisting of aliphatic amines, cycloaliphatic amines, poyamides, modified amines, polyoxyalkylenepolyamines, polyamidoamines, polyimidazolines, their derivatives, adducts or modifications.

20. The composition of claim 1 wherein said curing agent comprises one or more catalysts.

21. (canceled)

22. (canceled)

23. The composition of claim 1 wherein said mineral and/or ceramic fillers, fibers and/or aggregate are selected from the group consisting of aluminum oxide, corundum, garnet, glass, metal grains, nepheline syenite, feldspar, micas, barites, talc, clays, pumice, magnesium oxide, slags, tungsten carbide, wollastonite, ceramic or mineral fibers, ceramic or glass frits, ceramic spheres, and mixtures thereof.

24. The composition of claim 1 wherein the particle size of said aggregate is from about 325 to 8 mesh.

25. The composition of claim 1 comprising inorganic or mixed metal oxide pigments.

26. The composition of claim 1 wherein the weight ratio of base to curing agent is from about 7:1 to about 4:1.

27. (canceled)

28. The composition of claim 1 wherein the VOC of said composition is less than 100 g/l.

29. The composition of claim 28 wherein the VOC of said composition is less than 50 g/l.

30. The composition of claim 1 wherein the high heat exposure is 260° C. for 90 minutes.

31. The composition of claim 1 wherein the high heat exposure is four cycles of heating to 260° C. for 90 minutes followed by cooling at ambient temperature for 30 minutes.

32. The composition of claim 31 wherein the high heat exposure is twelve cycles of said heating and cooling.

33. The composition of claim 32 wherein the high heat exposure is sixteen cycles of said heating and cooling.
